(19) United States
(12) Patent Application Publication
(10) Pub. No.: US 2006/0146452 A1
(43) Pub. Date: Jul. 6, 2006

(54) CIP GMR enhanced by using inverse GMR material in AP2

(76) Inventors: Min Li, Dublin, CA (US); Simon Liao, Fremont, CA (US); Kunliang Zhang, Santa Clara, CA (US); Rachid Sbiaa, Saku-City (JP)

Correspondence Address: STEPHEN B. ACKERMAN, 28 DAVIS AVENUE, POUGHKEEPSIE, NY, 12603, US

(21) Appl. No.: 11/028,742

(22) Filed: Jan. 4, 2005

(51) Int. Cl. G11B 5/33; G11B 5/127

(52) U.S. Cl. 360/324.11

(57) ABSTRACT

Improved performance of CIP GMR devices has been achieved by modifying the composition of AP2. Said modification comprises the addition of chromium or vanadium to AP2, while still retaining its ferromagnetic properties. Examples of alloys suitable for use in AP2 include FeCr, NiFeCr, NiCr, CoCr, CoFeCr, and CoFeV. The ruthenium layer normally used to effect antiferromagnetic coupling between AP1 and AP2 is retained.

### RELATED PATENT APPLICATIONS

This application is related to docket number FP03-0320-00, filed as U.S. patent application Ser. No. ______, and filed on Jun. 18, 2004.

### FIELD OF THE INVENTION

The invention relates to the general field of magnetic disk recording with particular reference to GMR read heads having synthetic pinned layers.

### BACKGROUND OF THE INVENTION

The principle governing the operation of most magnetic read heads is the change of resistivity of certain materials in the presence of a magnetic field (magneto-resistance or MR). Magneto-resistance can be significantly increased by means of a structure known as a spin valve where the resistance increase (known as Giant Magneto-Resistance or GMR) derives from the fact that electrons in a magnetized solid are subject to significantly less scattering by the lattice when their own magnetization vectors (due to spin) are parallel (as opposed to anti-parallel) to the direction of magnetization of their environment.

As shown in FIG. 1, a spin valve structure has three magnetic layers: free layer 17 as well as AP1 layer 15, and AP2 layer 13. Free layer 17 is free to rotate in response to external fields. The AP2 direction is fixed by antiferromagnetic layer 12 (typically MnPt) with ruthenium layer 14 being used to provide the antiferromagnetic coupling. The relative magnetization directions of AP1 and AP2 during device operation are always antiparallel to one other. It is normal practice to utilize the same material (like CoFe) for both AP1 and AP2. This results in a positive bulk spin asymmetry coefficient β, as well as positive interface spin asymmetry coefficient γ.

β is defined as 1−ρ↑/(2ρ)=ρ↓/(2ρ)−1 where ρ↑, ρ↓ are the resistivity of spin up and spin down electrons, respectively. ρ is the material resistivity (=ρ↑ρ↓/ρ↑t+ρ↓). γ is defined as 1−r↑/2r_{b})=r↓/(r↑+r↓) where r↑(r↓) is the interface resistance for spin up and spin down electrons; r_{b}=(r↑r↓)/r↑+r↓). When r↑=r↓, γ will be 0 and the interface has no spin dependent scattering. Also seen in FIG. 1 is seed layer 11, capping layer 18 and non-magnetic spacer layer 16.

In TABLE I we show the β and γ magnitudes for the three magnetic layers together with the resulting magnitude of their resistivity for both up and down electrons for both the parallel and antiparallel states:

TABLE I
(Ru between AP1 and AP2)

| | | | resistivity in P state | | resistivity in AP state | |
|---|---|---|---|---|---|---|
| LAYER | β | γ | spin up | spin down | spin up | spin down |
| CoFe (free) | >0 | >0 | low | high | high | low |
| CoFe (AP1) | >0 | >0 | low | high | low | high |
| CoFe (AP2) | >0 | >0 | high | low | high | low |

The consequences of this are that the AP2 contribution to the GMR is always negative so it reduces the resistance contrast between the parallel and anti-parallel states of the free layer. This limits the GMR ratio as well as dRA (change between parallel and anti-parallel resistance) for synthetically pinned spin valves.

At this point we note that GMR devices come in two varieties. In the first type, the GMR change is measured in a direction parallel to the plane of the free layer. This is referred to as a CIP (current in plane) device. In the second type, the GMR change is measured in a direction perpendicular to the plane of the free layer. This is referred to as a CPP (current perpendicular to plane) device.

In an earlier invention (U.S. Pat. No. 6,683,762 issued Jan. 27, 2004), we disclosed a CPP device in which AP2 was made to provide a positive contribution to the GMR. This was achieved by using alloys containing chromium for AP2 and by using chromium in place of ruthenium as the AFM coupling layer.

Theoretical studies in the form of simulation were undertaken to determine whether or not the application of this approach to CIP devices would yield similar improvements. The results were disappointing in that GMR enhancements of less than about 5% were predicted by the simulations. Despite this discouraging outcome, it was decided to build a few CIP test units that used similarly modified AP2 layers. Unexpectedly, said units gave GMR improvements of the order of 15% as will be described in greater detail below. The reason for this discrepancy between the theoretical and experimental results is believed to be twofold:

(a) Various parameters, such as interface resistance and spin up/down channel resistivity used by the simulation routine, are for a particular set of growth conditions, seed layer, etc. which are different from those used in this case (b) The simulation does not take into account certain expected side effects of the present invention such as smoother Cu/free layer and Cu/AP1 interfaces as well as the improved IrMn growth associated with the presence of FeCr in AP2.

A routine search of the prior art was performed with the following reference of interest being found:

In U.S. Pat. No. 6,146,776, Fukuzawa et al. disclose a spin valve that includes an AP1/AP2 sub-structure.

### SUMMARY OF THE INVENTION

It has been an object of at least one embodiment of the present invention to provide a CIP GMR device having an improved GMR ratio.

Another object of at least one embodiment of the present invention has been that the pinned layer of said CIP device be synthetically pinned.

A further object of at least one embodiment of the present invention has been that said CIP device have a performance that is at least as good as that of one having a directly pinned layer while continuing to enjoy the stability associated with a synthetically pinned layer.

Still another object of at least one embodiment of the present invention has been to provide a process for manufacturing said CIP device.

These objects have been achieved by modifying the composition of AP2. Said modification comprises the addition of chromium or vanadium to AP2, while still retaining its ferromagnetic properties. Examples of alloys suitable for use in AP2 include FeCr, NiFeCr, NiCr, CoCr, CoFeCr, and CoFeV. The ruthenium layer normally used to effect antiferromagnetic coupling between AP1 and AP2 is retained.

### BRIEF DESCRIPTION OF THE DRAWINGS

FIG. 1 shows a CIP GMR unit of the prior art.

FIG. 2 shows a topspin valve whose AP2 layer has been formed according to the teachings of the present invention.

FIG. 3 is a closeup view of layer 23 of FIG. 2.

FIG. 4 is a bottom spin valve whose AP2 layer has been formed according to the teachings of the present invention.

FIG. 5 is a dual spin valve whose AP2 layers have been formed according to the teachings of the present invention.

### DESCRIPTION OF THE PREFERRED EMBODIMENTS

The basic novel feature of the invention is the use of chrome containing magnetic alloys, such as FeCr, as the material for AP2. The resulting negative β, enables the AP2 resistance contribution to have the same sign as AP1, which is equivalent to an increase of the AP1 thickness which in turn leads to an enhancement of the CIP GMR.

We will now describe the process(es) for manufacturing the present invention. In the course of this description the structure(s) of the invention will also become clear.

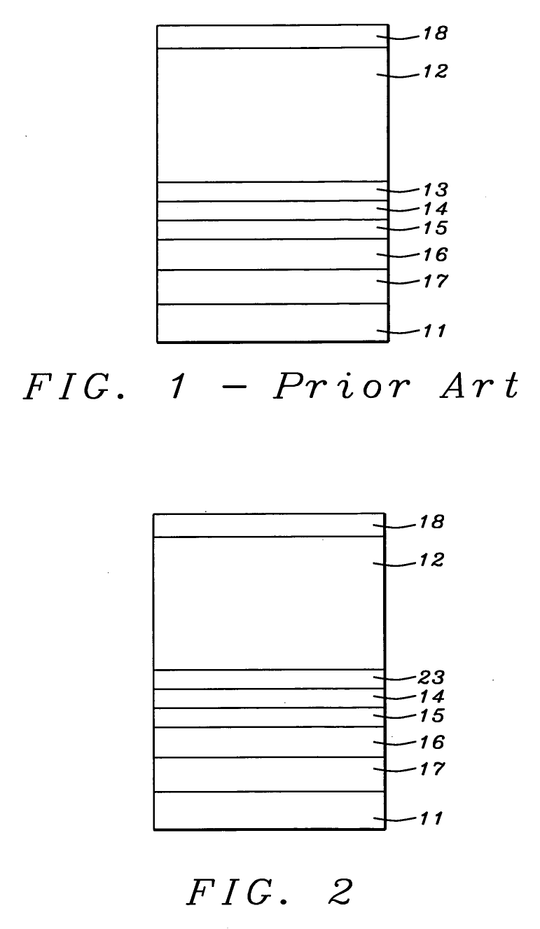

Referring now to FIG. 2, the process of the present invention begins with the deposition of free layer 17 on seed layer 11. Next, non-magnetic spacer layer 16 is deposited onto free layer 17. Then, AP1 layer 15 (typically CoFe between about 15 and 30 Angstroms thick) is deposited onto layer 16. This is followed by the routine deposition of AFM coupling layer 14 (typically ruthenium) onto AP1 layer 15.

Now follows a crucial step. AP2 layer 23, that is a magnetic alloy which includes chromium, is deposited onto AFM coupling layer 14. The process then concludes with the deposition of pinning layer 12 onto AP2 layer 23 followed by the deposition of capping layer 18 onto pinning layer 12.

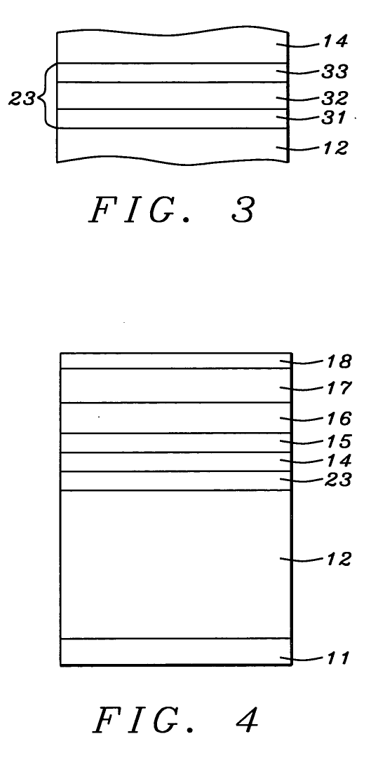

For layer 23 we have tended to prefer FeCr but this is by no means the only possible choice for AP2. For example, as illustrated in FIG. 3, AP2 could be a laminate of FeCr 32 sandwiched between two CoFe layers 31 and 33 of equal thickness. These two CoFe may have a combined thickness that is either greater or less than that of the FeCr layer. Typically, the AP2 layer has a total thickness between about 10 and 30 Angstroms.

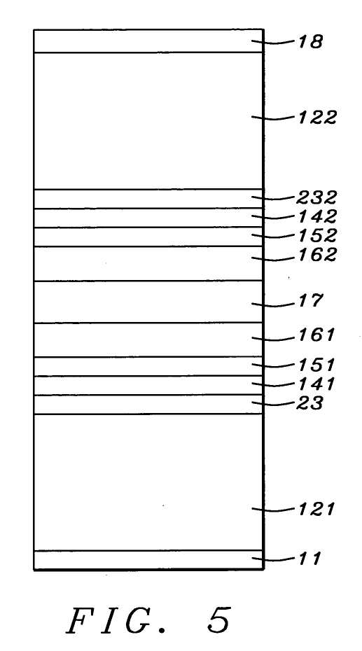

Other possible materials for AP2 that could be used in place of, or in combination with, FeCr include NiFeCr, NiCr, CoCr, CoFeCr, CoFeV, and FeV. Note, too, that the general approach to AP2 outlined above is applicable to both top spin valves (FIG. 2) and bottom spin valves (FIG. 4) as well as to a dual spin valve such as shown in FIG. 5. In the latter case, layers 121 and 122 are AFM layers, layers 231 and 232 are AP2 layers, formed according to the principles outlined above, layers 141 and 142 are AFM coupling layers, layers 151 and 152 are AP1 layers, and layers 161 and 162 are copper spacer layers.

An example of two such experimental film configurations with varying FeCr (inverted GMR) of various thicknesses (in Angstroms) as wafers 03 and 05, together with a reference configuration, wafer-01

TABLE II

| | | AFM | | | | AFM | |
|---|---|---|---|---|---|---|---|
| | AP1 | coupler | AP2 | | | layer | cap |
| sample | CoFe | Ru | CoFe | FeCr | CoFe | IrMn | NiCr |
| 01 | 20 | 8 | 15 | 0 | 0 | 70 | 30 |
| 03 | 20 | 8 | 7 | 7 | 5 | 70 | 30 |
| 05 | 20 | 8 | 3 | 12 | 3 | 70 | 30 |

Table III below summarizes the CIP GMR properties of the three structures detailed above:

TABLE III

| sample | MR | R | DR | Hin | Hc | Hpin |
|---|---|---|---|---|---|---|
| 01 | 12.28 | 19.9 | 2.444 | 19.0 | 15.0 | 1,707 |
| 03 | 13.7 | 19.8 | 2.713 | −14 | 16 | >2 kOe |
| 05 | 14.58 | 18.9 | 2.756 | −11 | 12 | >2 kOe |

These results show the effect of the inverted GMR. When there is FeCr in AP2, the CIP GMR is increased from 12.3% to 13.7 and 14.6% for the two examples shown. The DR value has also increased significantly. Hpin, the pinning strength, which is an important property for synthetically pinned films, can also be seen to have improved. Other results (not shown) have demonstrated that this type of AP2 design leads to improvements in bottom spin valves as well as in (the upper part of) dual spin valves.

As already discussed above, in addition to FeCr there are other materials such as NiFeCr, NiCr, CoCr, CoFeCr, CoFeV, FeV, etc. which can be used to obtain similar effects.

What is claimed is:

1. A process to manufacture a CIP top spin valve, comprising:
depositing a free layer on a seed layer;
depositing a non-magnetic spacer layer on said free layer;
depositing an AP1 layer on said non-magnetic spacer layer;
depositing an AFM coupling layer on said AP1 layer;
depositing an AP2 layer, that comprises FeCr, on said AFM coupling layer;
depositing a pinning layer on said AP2 layer; and
depositing a capping layer on said pinning layer.

2. The process recited in claim 1 wherein said AP2 layer consists of FeCr.

3. The process recited in claim 1 wherein said AP2 layer further comprises a layer of FeCr sandwiched between two CoFe layers of equal thickness.

4. The process recited in claim 3 wherein said two CoFe layers together have a thickness that is greater than that of said FeCr layer.

5. The process recited in claim 3 wherein said two CoFe layers together have a thickness that is less than that of said FeCr layer.

6. The process recited in claim 1 wherein said AP2 layer has a total thickness between about 10 and 30 Angstroms.

7. A process to manufacture a CIP top spin valve, comprising:
depositing a free layer on a seed layer;
depositing a non-magnetic spacer layer on said free layer;
depositing an AP1 layer on said non-magnetic spacer layer;
depositing an AFM coupling layer on said AP1 layer;
depositing an AP2 layer, that comprises one or more materials selected from the group consisting of NiFeCr, NiCr, CoCr, CoFeCr, CoFeV, and FeV, on said coupling layer;
depositing a pinning layer on said AP2 layer; and
depositing a capping layer on said pinning layer.

8. A process to manufacture a CIP bottom spin valve, comprising:
depositing a pinning layer on a seed layer;
depositing an AP2 layer, that comprises FeCr, on said pinning layer;
depositing an AFM coupling layer on said AP2 layer;
depositing an AP1 layer on said AFM coupling layer;
depositing a non-magnetic spacer layer on said AP1 layer;
depositing a free layer on said non-magnetic spacer layer; and
depositing a capping layer on said free layer.

9. The process recited in claim 8 wherein said AP2 layer consists of FeCr.

10. The process recited in claim 8 wherein said AP2 layer further comprises a layer of FeCr sandwiched between two CoFe layers of equal thickness.

11. The process recited in claim 10 wherein said two CoFe layers together have a thickness that is greater than that of said FeCr layer.

12. The process recited in claim 10 wherein said two CoFe layers together have a thickness that is less than that of said FeCr layer.

13. The process recited in claim 8 wherein said AP2 layer has a total thickness between about 10 and 30 Angstroms.

14. A process to manufacture a CIP bottom spin valve, comprising:
depositing a pinning layer on a seed layer;
depositing an AP2 layer, that comprises one or more materials selected from the group consisting of NiFeCr, NiCr, CoCr, CoFeCr, CoFeV, and FeV, on said pinning layer;
depositing an AFM coupling layer on said AP2 layer;
depositing an AP1 layer on said AFM coupling layer;
depositing a non-magnetic spacer layer on said AP1 layer;
depositing a free layer on said non-magnetic spacer layer; and
depositing a capping layer on said free layer.

15. A process to manufacture a dual CIP spin valve, comprising:
depositing a first pinning layer on a seed layer;
depositing a first AP2 layer, that comprises FeCr, on said pinning layer;
depositing a first AFM coupling layer on said AP2 layer;
depositing a first AP1 layer on said AFM coupling layer;
depositing a first non-magnetic spacer layer on said first AP1 layer;
depositing a free layer on said non-magnetic spacer layer;
depositing a second non-magnetic spacer layer on said free layer;
depositing a second AP1 layer on said second non-magnetic spacer layer;
depositing a second AFM coupling layer on said first AP1 layer;
depositing a second AP2 layer, that comprises FeCr, on said first AFM coupling layer;
depositing a second pinning layer on said second AP2 layer; and
depositing a capping layer on said second pinning layer.

16. The process recited in claim 15 wherein either or both of said AP2 layer consist of FeCr.

17. The process recited in claim 15 wherein either or both of said AP2 layers further comprises a layer of FeCr sandwiched between two CoFe layers of equal thickness.

18. The process recited in claim 17 wherein either or both of said two CoFe layers in the same AP2 layer together have a thickness that is greater than that of the FeCr layer in that AP2 layer.

19. The process recited in claim 17 wherein either or both of said two CoFe layers in the same AP2 layer together have a thickness that is less than that of the FeCr layer in that AP2 layer.

20. The process recited in claim 15 wherein each AP2 layer has a total thickness between about 10 and 30 Angstroms.

21. A CIP top spin valve, comprising:
a pinning layer on a seed layer;
an AP2 layer, that comprises FeCr, on said pinning layer;
an AFM coupling layer on said AP2 layer;
an AP1 layer on said AFM coupling layer;
a non-magnetic spacer layer on said AP1 layer;
a free layer on said non-magnetic spacer layer; and
a capping layer on said free layer.

22. The spin valve described in claim 21 wherein said AP2 layer consists of FeCr.

23. The spin valve described in claim 21 wherein said AP2 layer further comprises a layer of FeCr sandwiched between two CoFe layers of equal thickness.

24. The spin valve described in claim 23 wherein said two CoFe layers together have a thickness that is greater than that of said FeCr layer.

25. The spin valve described in claim 23 wherein said two CoFe layers together have a thickness that is less than that of said FeCr layer.

26. The spin valve described in claim 21 wherein said AP2 layer has a total thickness between about 10 and 30 Angstroms.

27. A CIP top spin valve, comprising:
a pinning layer on a seed layer;
an AP2 layer, that comprises one or more materials selected from the group consisting of NiFeCr, NiCr, CoCr, CoFeCr, CoFeV, and FeV, on said pinning layer;
an AFM coupling layer on said AP2 layer;
an AP1 layer on said AFM coupling layer;
a non-magnetic spacer layer on said AP1 layer;
a free layer on said non-magnetic spacer layer; and
a capping layer on said free layer.

28. A CIP bottom spin valve, comprising:
a free layer on a seed layer;
a non-magnetic spacer layer on said free layer;
an AP1 layer on said non-magnetic spacer layer;
an AFM coupling layer on said AP1 layer;
an AP2 layer, that comprises FeCr, on said AFM coupling layer;
a pinning layer on said AP2 layer; and
a capping layer on said pinning layer.

29. The spin valve described in claim 28 wherein said AP2 layer consists of FeCr.

30. The spin valve described in claim 28 wherein said AP2 layer further comprises a layer of FeCr sandwiched between two CoFe layers of equal thickness.

31. The spin valve described in claim 30 wherein said two CoFe layers together have a thickness that is greater than that of said FeCr layer.

32. The spin valve described in claim 30 wherein said two CoFe layers together have a thickness that is less than that of said FeCr layer.

33. The spin valve described in claim 28 wherein said AP2 layer has a total thickness between about 10 and 30 Angstroms.

34. A CIP top spin valve, comprising:
a free layer on a seed layer;
a non-magnetic spacer layer on said free layer;
an AP1 layer on said non-magnetic spacer layer;
an AFM coupling layer on said AP1 layer;
an AP2 layer, that comprises one or more materials selected from the group consisting of NiFeCr, NiCr, CoCr, CoFeCr, CoFeV, and FeV, on said AFM coupling layer;
a pinning layer on said AP2 layer; and
a capping layer on said pinning layer.

35. A dual CIP spin valve, comprising:
a pinning layer on a seed layer;
a first AP2 layer, that comprises FeCr, on said pinning layer;
a first AFM coupling layer on said AP2 layer;
a first AP1 layer on said AFM coupling layer;
a first non-magnetic spacer layer on said first AP1 layer;
a free layer on said non-magnetic spacer layer;
a second non-magnetic spacer layer on said free layer;
a second AP1 layer on said second non-magnetic spacer layer;
a second AFM coupling layer on said first AP1 layer;
a second AP2 layer, that comprises FeCr, on said first AFM coupling layer;
a second pinning layer on said second AP2 layer; and
a capping layer on said second pinning layer.

36. The spin valve described in claim 35 wherein either or both of said AP2 layer consist of FeCr.

37. The spin valve described in claim 35 wherein either or both of said AP2 layers further comprises a layer of FeCr sandwiched between two CoFe layers of equal thickness.

38. The spin valve described in claim 37 wherein either or both of said two CoFe layers in the same AP2 layer together have a thickness that is greater than that of the FeCr layer in that AP2 layer.

39. The spin valve described in claim 37 wherein either or both of said two CoFe layers in the same AP2 layer together have a thickness that is less than that of the FeCr layer in that AP2 layer.

40. The spin valve described in claim 35 wherein each AP2 layer has a total thickness between about 10 and 30 Angstroms.
